(19) United States
(12) Patent Application Publication
(10) Pub. No.: US 2017/0148111 A1
(43) Pub. Date: May 25, 2017

(54) ANALYTIC FRAMEWORK FOR RAW MATERIAL VALUATION PROCESS UNDER MARKET UNCERTAINTIES

(71) Applicant: ExxonMobil Research and Engineering Company, Annandale, NJ (US)

(72) Inventors: Myun-Seok Cheon, Whitehouse Station, NJ (US); Shivakumar Kameswaran, Bridgewater, NJ (US); Anantha Sundaram, Annandale, NJ (US); Dimitri J. Papageorgiou, Stewartsville, NJ (US)

(21) Appl. No.: 15/335,627

(22) Filed: Oct. 27, 2016

Related U.S. Application Data
(60) Provisional application No. 62/258,596, filed on Nov. 23, 2015.

(51) Int. Cl. G06Q 50/04; G06Q 10/06; G06Q 50/18

(52) U.S. Cl. CPC G06Q 50/04; G06Q 50/188; G06Q 10/06315

(57) ABSTRACT

A raw material valuation tool to assist purchasing decisions in the operation of a facility. The decision support tool allows a user to apply a modeling and analysis framework for a raw material valuation process. This optimization model allows raw material purchasing decisions to be divided into scenarios ahead of time, thereby addressing operational and market uncertainties of events that occur between the initial planning/scheduling and the final arrival of the raw materials at the facility. Price and availability data of a set of raw materials are input into the optimization model, including probability of occurrence of such data. The model calculates an optimal raw material purchasing scenario, which extends up to a moment in time when the raw material is used at the facility. The flexibility of this optimization model increases revenue generated at the facility, decreases cost of the raw material and improves operational decisions.

### CROSS-REFERENCE TO RELATED APPLICATIONS

This application claims priority to U.S. Provisional Application Ser. No. 62/258,596 filed Nov. 23, 2015, which is herein incorporated by reference in its entirety.

### TECHNICAL FIELD

The presently disclosed subject matter relates to a modeling and analysis framework for a raw material valuation process that takes market uncertainties under consideration. In particular, the presently disclosed subject matter describes the raw material valuation process, which observes business analytic activity and which accounts for the value of each raw material and feed-stock for its operation.

### BACKGROUND

Raw material valuation process relates to an analytics tool that underlines decisions which a refinery makes while purchasing crude oil for its business needs and entails selecting, for example, a supplier of the desired crude in adequate amount for an optimal price.

In the process of purchasing crude oil, a refinery typically faces numerous choices among a variety of crudes that are available from many different suppliers at multiple geographic locations. Accordingly, the price and availability constraints of the desired crudes procured and shipped around the world cause the purchasing decisions to be made well ahead of the moment in time when the crudes are used at the refinery. In other words, while the purchasing decisions regarding certain crudes can be delayed until close to the moment when the refinery is ready to begin processing them, other crudes must be bought earlier in order to arrive on time at the refinery. Moreover, the prior and the latter crudes are often the crudes that are suitable to be mixed together at the refinery; hence, they need to be present at the same time and their procurement must be coordinated accordingly.

The fact that crudes which are purchased at different moments in time are often the ones that are used at the same time introduces inherent uncertainties in the raw material valuation process. For example, multiple crudes that are compatible to be mixed only with one another may be purchased several months apart from each other. During that time, however, the price of a crude oil yet to be purchased could substantially change due to a. myriad of market factors. Instances like this, where the refinery finds itself in a position that the only viable option is to purchase an overpriced crude oil result in a need for a more flexible planning in order to respond to dynamic and unforeseeable changes on the market.

Additional market factors that merit flexible response are, for example, changes in demand and supply of the end product. Namely, mixing and processing of the intended crudes produce a certain final product at the refinery. However, if, for example, the demand for another product increases in the course of time, it may become economically preferable to produce the product in higher demand, instead. This entails rearrangement of the processing decisions and modification of the end product in terms of content and/or quantity. The raw material needs to be obtained consistently with such rearrangement and the consequent changes in purchasing the corresponding crudes need to be made once the new market information is available.

Another similar planning and scheduling issue arises when availability of the required crude is affected by events at the supplier's location (e.g., political unrest in the area of the designated supplier, operational limitations or problems at the supplier's facility, etc.). In these cases, too, it is desirable to enable the raw material valuation process to accept the input at multiple stages, where a wait-and-see approach would address sudden and detrimental logistical challenges.

During the raw material valuation process, conventional optimization models do not explicitly incorporate market uncertainty, but instead rely on multiple independent optimization runs to perform sensitivity analysis.

The most commonly applied model of the existing technology uses a single point forecast approach. The current practice to handle the market uncertainty is through the sensitivity analyses by changing the point forecasts. Selected events at multiple stages are connected into scenarios. This single point forecast model selects variables that it considers most likely to occur (e.g., price) for each event at each stage of the process and forms a scenario with these events. Accordingly, the model produces a single stage decision on purchasing all of the necessary raw materials, regardless of the actual market developments that take place during subsequent stages, i.e., between the moment in time when the purchasing decision was made and the last stage when the raw materials are used. Consequently, if any of the variables that occur in actuality significantly deviate from the variable that the model selected as the most likely one, the resulting decision making process becomes undesirable.

In light of the discussed inadequacies of the existing technology and due to the inherent multi-stage dynamic structure of the decision-making process and the volatility of raw material prices, it is necessary to directly address market uncertainty and operational limitations within an optimization framework. An optimal raw-material diet assigned by including the operational, logistical and market uncertainties is significantly different and more valuable over a variety of pricing and demand scenarios than the one obtained without such considerations.

### SUMMARY

The presently disclosed subject matter relates to a modeling and analysis framework for a raw material valuation process. The embodiments of the present invention allow raw materials purchasing decisions at a refinery to be divided into scenarios ahead of time, thereby addressing operational and market uncertainties of events that occur between the initial planning/scheduling and the final arrival of the raw material at the refinery. The flexibility of this optimization model increases revenue generated at the refinery, decreases cost of the raw material and improves operational decisions,

In one embodiment, a method of raw material procurement optimization at a facility comprises: using a computer system that stores price and availability data of raw materials in a database, optimizing valuation of the raw materials by using a mathematical valuation model, wherein a raw material procurement scenario tree is created and divided into a plurality of stages in time, the scenario tree including a plurality of individual scenarios, wherein the price and availability data of the raw materials is assigned probability of occurrence in future stages in time and the data is input into the scenario tree, and wherein the mathematical valuation model processes the price and availability data of the raw materials including the probability of occurrence of the data, and calculates an optimal raw material procurement scenario among the plurality of individual scenarios, optimizing negotiating sequence by a mathematical negotiation model, wherein the negotiating sequence determines order of the raw material procurement, and performing procurement according to the calculated optimal raw material procurement scenario.

Each of the plurality of individual scenarios may include raw material procurement decisions that cumulatively amount to a full capacity of the facility. Further, each of the plurality of individual scenarios may extend from a moment in time of the calculation of the optimal raw material procurement scenario to a moment in time when the facility reaches the full capacity. In addition, each of the plurality of individual scenarios may include raw material procurement decisions at each of the plurality of stages of the scenario tree. The stored price and availability data of the raw materials may include a predicted price for each of the raw materials in the future stages of the scenario tree, and a volatility of each corresponding predicted price. The volatility of each corresponding predicted price may be determined based on historical market conditions. The database may include data regarding mutual compatibility among the raw materials. Moreover, each of the plurality of individual scenarios may account for the data regarding mutual compatibility among the raw materials. Decisions made at a node of the scenario tree may carry over to nodes of subsequent stages of the scenario tree originating from said node. The order of the raw material procurement may be based on negotiation of the price and the availability of the raw material.

In another embodiment, a method of raw material procurement optimization at a facility comprises: using a computer system that stores price and availability data of raw materials in a database, optimizing valuation of the raw materials by using a mathematical valuation model, wherein a raw material procurement scenario tree is created and divided into a plurality of stages in time, the scenario tree including a plurality of individual scenarios, wherein the stored price and availability data of the raw materials includes a predicted price for each of the raw materials in future stages of the scenario tree, and a volatility of each corresponding predicted price, wherein the mathematical valuation model processes the price and availability data of the raw materials including the volatility of each corresponding predicted price, and calculates an optimal raw material procurement scenario among the plurality of individual scenarios, optimizing negotiating sequence by a mathematical negotiation model, wherein the negotiating sequence determines order of the raw material procurement, and performing procurement according to the calculated optimal raw material procurement scenario.

Each of the plurality of individual scenarios may include raw material procurement decisions that cumulatively amount to a full capacity of the facility. Further, each of the plurality of individual scenarios may extend from a moment in time of the calculation of the optimal raw material procurement scenario to a moment in time when the facility reaches the full capacity. Moreover, each of the plurality of individual scenarios may include raw material procurement decisions at each of the plurality of stages of the scenario tree.

The volatility of each corresponding predicted price may be determined based on historical market conditions. The database may include data regarding mutual compatibility among the raw materials. Each of the plurality of individual scenarios may account for the data regarding mutual compatibility among the raw materials. Decisions made at a node of the scenario tree may carry over to nodes of subsequent stages the scenario tree originating from said node. The order of the raw material procurement may be based on negotiation of the price and the availability of the raw material.

### BRIEF DESCRIPTION OF THE DRAWINGS

FIG. 1 shows an example of a scenario tree of the present invention modeled across multiple stages in time.

FIG. 2 shows an example of improved decision making of the present invention regarding purchasing crude oil.

FIG. 3 shows three steps of the optimization process of the present invention.

FIG. 4 shows constraints that define individual scenarios.

FIG. 5 shows a case study that applies a stochastic model of the present invention.

FIG. 6 shows a comparative case study of a conventional optimization model.

FIG. 7 shows a comparison between the stochastic and the conventional model in terms of expected resulting profitability.

### DETAILED DESCRIPTION

The presently disclosed subject matter provides a tool for the raw material valuation process at a refinery. The tool is preferably a decision support tool, but is not intended to be so limited; rather, it is contemplated that other tools or means that enable raw material valuation are within the scope of the presently disclosed subject matter. The presently disclosed subject matter will be described in connection with one or more petrochemical facilities for purpose of illustration. It is intended that the presently disclosed subject matter may be used at any site where raw material purchasing decisions are a normal part of operating the site. The operation of a petrochemical facility may involve various decisions, including the process operations, blending operations, transportation of materials (e.g. feeds, intermediates, or products) to and/or from the facility (e.g. via maritime shipping, rail, truck, pipeline, etc.), cargo assignments, vessel assignments, evaluation and selection of raw or feed materials, and the timing of these activities. Examples of petrochemical facilities include, but are not limited to, refineries, storage tank farms, chemical plants, lube oil blending plants, pipelines, distribution facilities, LNG facilities, basestock production facilities, and crude, feedstock and product blending facilities. The presently disclosed subject matter may also be used in connection with facilities that produce and transport crude oil and/or refined intermediate and/or finished products including but not limited to chemicals, base stocks, and fractions. It is also contemplated that the presently disclosed subject matter may be used in other operations and facilities that are not associated with petroleum and petrochemical processing, but where raw material purchasing issues are present.

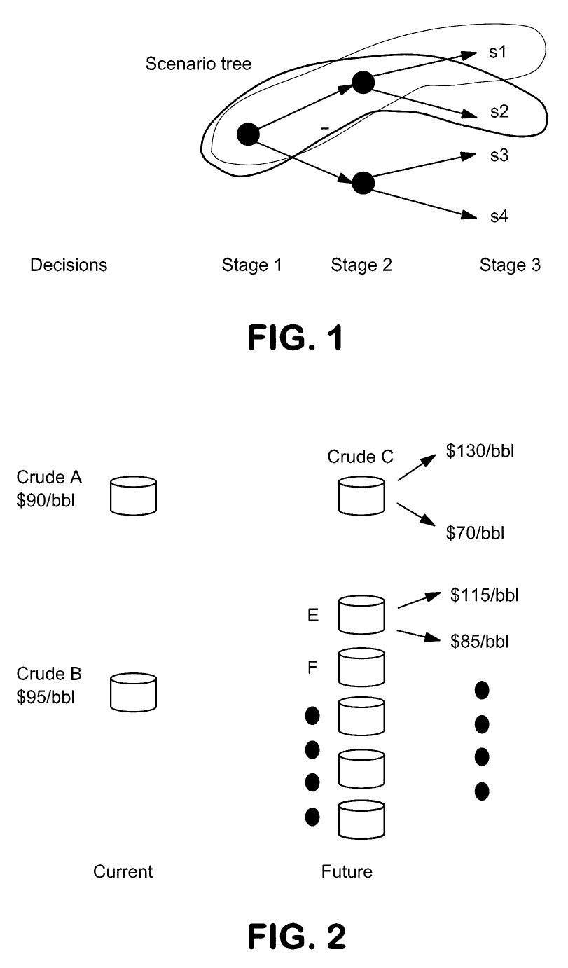

FIG. 1 shows an example of the raw material valuation process divided horizontally into multiple chronological stages and vertically into nodes which represent decision making junctions. This model is referred to as a “scenario tree,” where several nodes connected across multiple stages constitute a raw material valuation scenario.

Each stage of the valuation process may be, for example, one month later in time than the previous one. In stage 1, the refinery may make some purchasing decisions, but not all. More specifically, only the decisions that cannot be delayed are made in order to ensure that the purchased raw material arrives at the refinery when needed for processing, or in order not to lose opportunities available only in stage 1. Subsequently, the scenario tree advances to the nodes (decision markers) in the next stage, stage 2. In this example, the purchasing decisions that have already been made in stage 1 are compatible with multiple options to select from, i.e., the multiple nodes of stage 2.

In this embodiment, certain selections of stage 2 are left undetermined to be decided upon a month later, or two months later, in stage 3. Accordingly, once operational and market developments that occur between stage 1 and stage 3 transpire, the decision making process at the refinery can be adjusted in light of these events, and the flexibility of accounting for such events can replace the rigid calculation technique of the conventional methodology. In other words, this embodiment allows for a wait-and-see approach, where, for example, prices of various crudes change in time and what was an element of uncertainty in stage 1 becomes available information in stage 2. An option to respond to such change as it happens improves the results of the raw material valuation in comparison with the currently existing model, which makes binding decisions ahead of time and attempts to predict the most likely future events.

The advantage of the flexible approach of the embodiment described above is illustrated in the example of FIG. 2. The raw material valuation process of this example is represented by two stages, the current stage and the future stage. In the current stage, the refinery makes a selection whether to purchase crude A or crude B. Currently, crude A sells for $90/bbl while the price of crude B is $95/bbl. At this stage, the refinery is confronted with a selection that is permanent and that affects other segments of the purchasing process.

Moreover, in this example, whichever crude is selected in the current stage requires an additional crude oil for the two to be mixed in order to produce a desired end product. However, from the processing standpoint, crude A adequately mixes only with crude C, while crude B properly mixes with any of the crudes E, F, etc. In addition, a range of possible prices for crude C is from $70-130/bbl, while the price range for crudes E, F, etc. is less volatile, i.e., $85-115/bbl. Of note, crudes E, F, etc. are multiple crude oils and any one of them alone satisfies the mixing requirements with crude B. Thus, selecting any of them entails selecting the one with the best price or with the most desirable chemical content in combination with crude B.

The conventional technology selects the most probable value for the future events, which in this example translates into the assessment that the future prices of the crudes would be their average prices. With this taken into the account, the average value for the price range of crude C is $100/bbl, but so is the average value for crudes E, F, etc. Being that the conventional methods make all of the selections at once, i.e., in the current stage, a refinery that applies the existing technology would purchase crude A, since it is less expensive than crude B, considering that the predicted (average) prices of the crude that mixes with crude A (crude C) and the crudes that mix with crude B (crudes E, F, etc.) are the same ($100/bbl). Notably, crude B offers a capability to mix with a broader span of future crudes, i.e., multiple crudes could be selected in the future, while crude A requires specifically crude C in the next stage.

The existing optimization tools would not be able to utilize the versatility of crude B, because the computing model would treat any of the crudes E, F, etc. the same. This is because the average, most probable price for each one of those crudes is $100/bbl, which is also the most probable price of crude C. The conventional model would conclude that there would seemingly be no advantage to select crude B in the current stage, when it is the more expensive option between the two, and when it is no more likely to invoke a less expensive future crude oil to mix with. However, such conclusion may become detrimental in the future, in case that the most volatile crude in terms of the price, crude C, increases in price substantially, while any single one of the crudes mixable with crude B decreases in price or remains stable. Such a development would more than cancel the potentially short-sighted advantage of the current price comparison between crudes A and B, in case that the unpredictable change in price of crude C ends up being unfavorable in comparison with the change in price of any one of the crudes E, F, etc. in the future.

One example of the present invention enables the raw material valuation process to take advantage of favorable future pricing of one of the crudes E, F, etc. In contrast with the conventional technology, one embodiment of the present invention is a decision making model, which enables a refinery to optimize raw materials to be purchased in multiple stages. One crude oil (crude A or B) would be procured in the current stage and then, in accordance with this selection, a decision would be made to purchase a crude oil in the future that is best increases profitability of the refinery. This capability would allow the refinery to benefit from the versatile qualities of crude B, for example, even though this crude is presently more expensive.

Namely, if the refinery selects crude B in the current stage, on one hand, it would pay $95/bbl and crude C would be eliminated from further consideration as incompatible with crude B. However, the raw material valuation model would allow the refinery to observe the market circumstances surrounding crudes E, F, etc., because all of them properly mix with the selected crude B. As a result, the refinery would be able to select the optimal option among them, in terms of price, availability and quantity with an end product in consideration, at the moment in time when such information would be actually available to the refinery. This feature of the informed future decision making, which addresses the uncertainty of the variables resulting from the events between the current and the future stage, is far superior to simply assigning the highest probability to unknown variables and making undesirably limiting decisions in the current stage before any of the events occur.

Specifically, in the example of FIG. 2, if any of the crudes E, F, etc. favorably changes in price at the moment of realization in comparison with the price change of crude C, and such difference is greater than the initial cost of selecting crude B over crude A, the favorable change in price would justify the decision to purchase the more expensive crude B in the first place. In other words, the flexibility of the raw material valuation model of the present embodiment would materialize in this example.

Yet another benefit of making decisions in stages relates to demand and supply of the refinery's end product on the market. For example, in addition to selecting the least expensive suitable crude, choice of the raw material may be dependent on the content and the quantity of the processed end product. Namely, in case that in stage 2 the demand for, for example, diesel substantially increases on the market, while, for example, the supply of gasoline surges, the price of the prior would rise and the price of the latter would drop. Hence, it is financially desirable for the refinery to adjust to such developments. One example of the raw material valuation process of the present invention enables such adjustment by allowing the refinery to provide a crude diet in stage 2 that is better suited for production of diesel than gasoline. As a result, the refinery is able to respond to the market uncertainties and produce larger quantities of end product (diesel in this example) in the environment when selling diesel would be more profitable than selling gasoline.

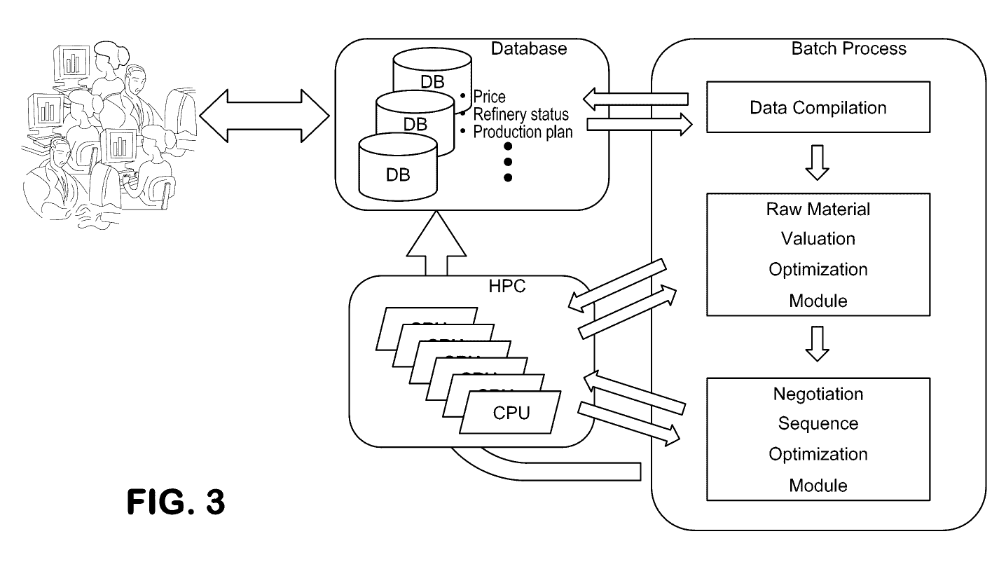

Further, one example of the raw material valuation model is an optimization process shown in FIG. 3, which includes three steps. The first step is data collection and compilation for the optimization problem instances from the database system. The second step is invoking the optimization module to find multiple optimal or near optimal crude/feedstock acquisition strategies. The third step is the negotiation sequence optimization. The latter two optimization steps may be performed in a high performance computing environment. The main user interface may be via web services to the database.

The first step of data compilation may be based on the historical performance of various crudes in terms of price fluctuations and factors that affect the change in price, the status of each supplier's refinery regarding operational capabilities, the production plan of raw materials at each supplier's facilities, etc. In this step, information from multiple databases pertaining to price and availability of different crudes from numerous locations worldwide may be assembled and made available to the optimization model.

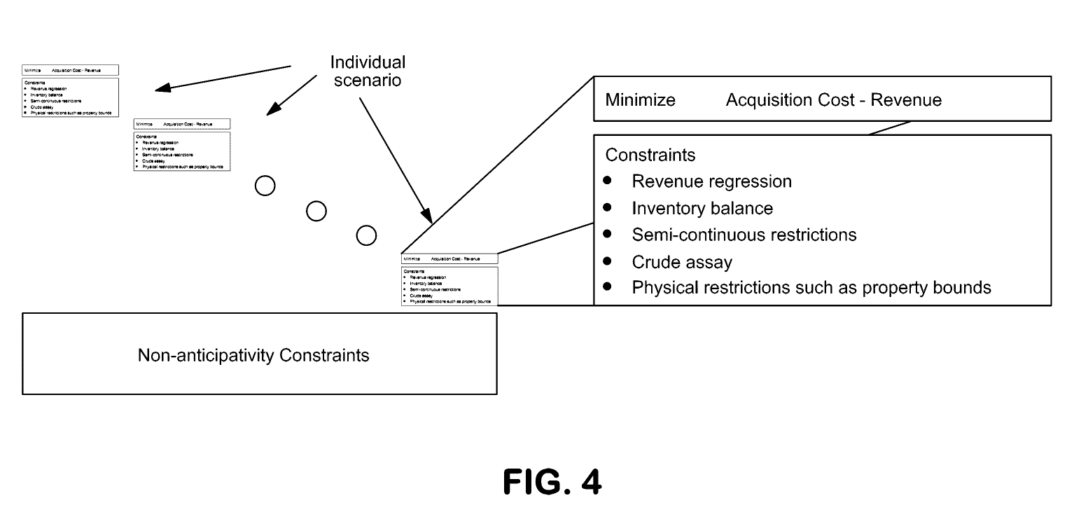

The second step, i.e., the raw material valuation optimization may be used to create the scenario tree and may be in the form of mixed integer multi-stage stochastic programming problems. One example of the structure of the problem is described in FIG. 4. The problem has a block diagonal structure, where each block corresponds to a specific scenario, and a set of coupling constraints, which ensure no discrepancy on shared decisions that appear in different scenarios. For example, if two scenarios share the exact same price realization path to the previous stage, then the decisions in the previous stages should be same.

Consider, for example, encircled scenarios s1 and s2 in FIG. 1. Both scenarios follow the same price realization up to stage 2. Therefore, their corresponding stage 1 and stage 2 decisions are the same.

More specifically, as illustrated in FIG. 4, the scenarios may be block-diagram individual scenarios. An individual scenario may encompass the events and the decisions starting with the root node of the scenario tree up until the last stage of the model when the crudes arrive at the refinery. The model may provide a solution for each individual scenario and the corresponding solutions may be different for each scenario.

The model may include “non-anticipativity constraints,” which means that once a decision at a node in FIG. 1 has been made, all of the future stages that progress (branch out) from such node are permanently bound by the decision made at their preceding node. Consequently, all of the future purchasing activities that originate from this node are affected by the decision made at the predecessor node. At the same time, the future stages in FIG. 1 that branch out from a different preceding node are not affected by this decision, but are, instead, constrained by the decision made in the node that they themselves branch out from. For example, scenarios s3 and s4 incorporate a different set of constraints introduced in stage 2 than scenarios s1 and s2.

Revenue regression related constraints may be dispositive of what the predicted revenue would be if a certain set of crudes is selected and procured. In other words, if a refinery processes certain types of crude at determined quantities, a specific amount of end product would be produced, which, at the market price at the moment of production would result in generated revenue. Thus, raw material purchasing decisions at various stages would directly affect the revenue generated at the moment of market realization.

Inventory balance constraints may be defined by the storage capacity of the refinery. The amounts of crudes purchased and the proportions that they are mixed at must amount to a quantity of the end product that is less or equal to the quantity that the petroleum facility is able to store.

Turning to semi-continuous restrictions, raw materials transportation decisions need to be mindful of flat cost of vessels that are incurred regardless of whether a particular vessel carries crude oil up to its entire capacity or merely a portion. In other words, a refinery may plan to order an amount of crude that, once divided among multiple vessels, occupies nearly the maximum capacity of each vessel, in order to optimize the amount of crude transported for the cost of the transportation.

Crude assay constraints are related to revenue regression as they determine the chemical properties of the purchased raw material and its ability to mix and react with the other compatible raw materials. Consequently, different crudes would mix differently with one another and produce end products of different qualities and in different amounts. A price and a quantity of an end product would, in turn, affect the market realization of the product and determine the revenue that the refinery would make from the sale of the product.

Finally, physical restrictions of the raw material such as property bounds are different physical or chemical properties (e.g., impurities content) of the crudes that the facilities (tanks, pipes, etc.) of the refinery may be affected by. The extent to which the refinery can adequately handle such properties with no detrimental effect on its facilities in terms of quality or integrity of the refining process may be limited. As a function of such limitations, the properties of the crudes delivered at the refinery need to comply with the limitations of the refinery's facilities.

Subsequent to the step of raw material valuation optimization in FIG. 3 may be the third step of negotiation sequence optimization. At any particular month, the refinery may purchase multiple crudes from multiple suppliers. By analyzing the optimal solution, the refinery may decide which crude needs to be negotiated first in terms of price.

For example, as shown in FIG. 2, the model indicates that, among crudes A, B, C, F, etc., crudes A and B need to be negotiated first, being that the initial purchasing decisions pertain to these two crude oils. In certain instances, even when at first the selected strategy aligns with the path of crude B procurement, if the results of the negotiation of the price of crude A are substantially more advantageous in comparison with the outcome of the crude B negotiations, the raw material purchasing strategy may be switched to the path of crude A. Thus, the result of the negotiation step may be an dispositive factor in deciding whether to select the path of crude A or crude B in the future and this selection may affect the choice of the future crudes (C, D, E, F, etc.) and accordingly their respective negotiations.

Case Study—Comparison with Conventional Technology

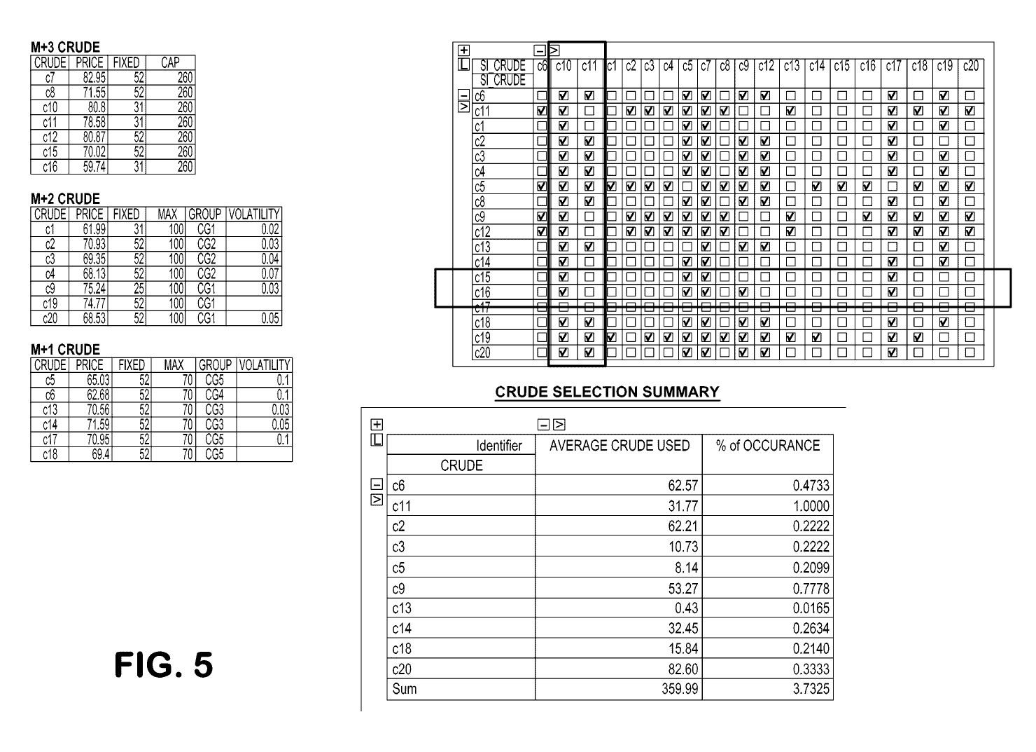

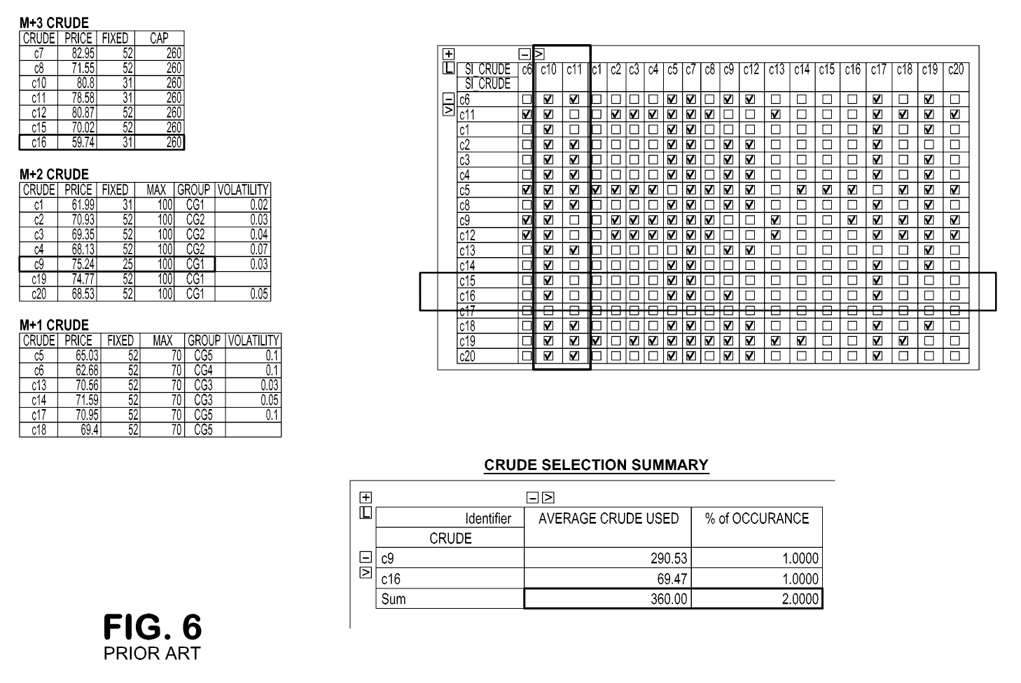

FIG. 5 illustrates a case study performed by applying one example of the optimization model of the present invention. FIG. 6 shows an analogous example of the conventional technology that uses the same database of crude oils. The data input includes 20 types of crude oil (c1-c20) represented by three tables: M+3 crude oils, M+2 crude oils and M+1 crude oils. The M+3 table represents crudes that need to be purchased three months ahead of the processing date (month M), the M+2 table corresponds to crudes to be procured two months ahead, and the M+1 table identifies the group of crude oils to be obtained one month prior to the processing.

At the moment when the model is implemented, i.e., the M+3 moment in time, the actual market information about the M+3 crudes is available, but the exact market data regarding the M+2 and M+1 crudes is not. As a result, the M+3 table includes the actual price of each crude oil with no volatility information, because this is the known market price at the moment when the oil is purchased. In comparison, some of the M+2 crudes will be purchased one month later and some of the M+1 crudes two months later, and their corresponding prices are represented with ranges rather than exact values. These ranges can be obtained by applying the volatility percentage on each of the average prices, which are available in the M+2 and the M+1 tables. For example, crude c1, available in the M+2 month is predicted to realize at $61.99/bbl, with +/−2% volatility (uncertainty).

Moreover, the tables also include the fixed cost (i.e., shipping cost) for a number of units up to the maximum capacity MAX/CAP (260 units in the M+3 month, 100 units in the M+2 month and 70 units in the M+1 month). Finally, the geographic regions where the M+2 and the M+1 crudes are expected to be available are designated with groups CG1-CG5.

FIG. 6 is an example that shows how the existing technology would be applied on the same data set as the data input included in the example of the present invention illustrated in FIG. 5. Of note, even though the data regarding price volatility may be available to a refinery, the conventional model would not process a range of prices, but would, instead, input a single price value, which is most commonly the average value. Thus, the data processing of the conventional model is conducted in the M+3 moment in time when crude c16 is selected for purchase as the least expensive crude that month, for example.

However, as also shown in FIG. 6, certain crudes mix adequately with many other crudes (indicated by a check in a box) and some crudes mix only with few. For example, among the crudes available in the M+3 month, crudes c10 and c11 mix properly with more crude oils than crude c16. One drawback of the current technology is that the only option to utilize this versatility of crudes c10 and c11 is to simply purchase one of these oils in the M+3 month in anticipation that the market uncertainty of one of their compatible crudes will turn out favorably in the future. Being that the conventional model does not provide any tool to predict probability of a favorable occurrence within a range of uncertainties, the model would normally select the known least expensive crude c16 at the M+3 stage. In this example, 69.47 bbl of crude c16 is obtained for a refinery with a required capacity of 360bb1.

Next, a month later (the M+2 month), the refinery seeks to buy the quantity of oil sufficient to satisfy the remaining capacity of the refinery (360 bbl-69.47 bbl). At that moment in time, the raw material purchasing scenario established at the M+3 stage dictates crude c9 to be purchased. Crude c9 is mixable with crude c16 and it is available to the extent necessary to reach the entire capacity of the refinery. However, the price of crude c9 might have changed meanwhile on the market to vary from the input average price, but the current model would not address this uncertainty in the M+3 month, when the raw material valuation scenario was set and when crude c16 was purchased. Accordingly, in the M+2 month, the refinery would purchase 290.53 bbl of crude c9 for whatever price this crude is available on the market (the price of realization). Consequently, the refinery would obtain the crude oil up to its full capacity necessary for the operations that will take place in month M. In an instance where price of crude c9 would increase significantly, or in case that any other crude that is not mixable with crude c16 becomes cheaper, a refinery that uses the conventional technology would not be able to respond to such market trend in the M+2 months, due to the decisions made in the M+3 month.

FIG. 5 illustrates the raw material optimization model of one embodiment of the present invention applied on the same data set as discussed above. Namely, in this example the 20 types of crude oil (c1-c20) represented by the three tables have the same characteristics in terms of pricing and mutual compatibility. Nevertheless, the optimization model applied may account for the market uncertainty surrounding these crudes. Specifically, the price volatility information may be considered and processed.

The model may combine crudes that are mixable with one another and that cumulatively add up to the full capacity of the refinery (360 bbl). Numerous possible combinations form a scenario tree, simplified in FIG. 1, where each of the feasible scenarios entails procurement of several crude oils throughout months M+3, M+2 and M+1 in order to satisfy the required capacity of the refinery. As shown in FIG. 5, the model may compute probability of occurrence of the predicted market price fir each of the crudes based on its price volatility. Accordingly, the model may produce the optimal scenario in light of the cumulative purchase of multiple crudes at different moments in time up until the total capacity of the refinery is reached. Such scenario may be available to the refinery in the M+3 month when the initial purchasing decisions are to be made that will have a binding effect on the future decisions.

For example, the optimization model may provide an answer in the M+3 month whether to purchase the less expensive crude c16 and limit the future options, or to buy the more expensive crude c11 and retain the flexibility in the following months. Such decision may revolve around, for example, high likelihood that the realization of the compatible crudes in the following months will be favorable in comparison with the conservative and potentially rigid decision to simply select the cheapest crude right at the outset. The solution illustrated in FIG. 5 is an example of an optimal answer (scenario) that a refinery would have available in the M+3 month based on the market uncertainties included in the computation.

In the presented example, the model would suggest buying a certain quantity of crude c11 (31.77 bbl) in the M+3 month, even though it is not the least expensive crude available that month. Additional information from this optimal scenario may be that the future crudes mixable with crude c11 would likely be available in required quantities for the desired price (percentage of occurrence) in order to complete the total purchase of the raw material up to the refinery's capacity of 360 bbl. This far-sighted stochastic solution would produce better overall raw material valuation decisions in comparison with the short-sighted conventional technique of ignoring market uncertainties and simply selecting the cheapest crude available at the moment.

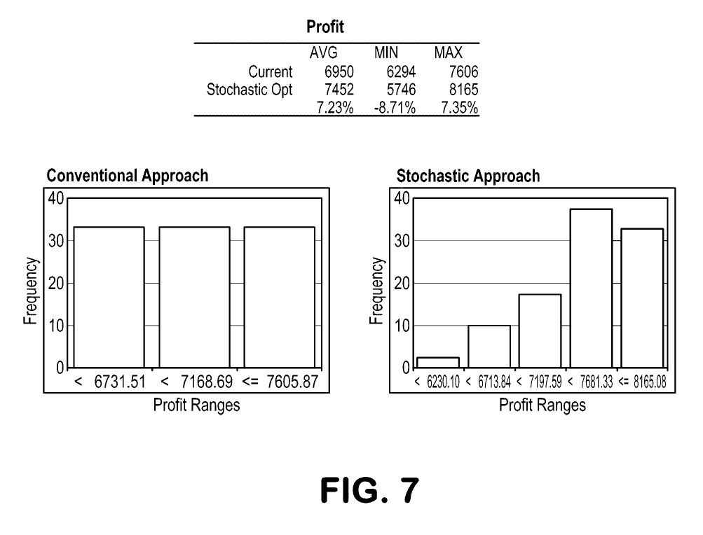

FIG. 7 shows the comparison between profitability resulting from the raw material purchasing decisions produced by the conventional approach discussed in reference to FIG. 6 and the stochastic approach presented in FIG. 5. The average expected profit for the example of the conventional approach is $6,950, compared to the average expected profit computed for the stochastic approach of the described embodiment of the present invention, which is $7,452. Thus, the case study that applied the stochastic optimization model resulted in the increase of 7.23% of the expected average profitability.

Moreover, the comparison between the statistical distributions of profitability between the two models indicates that the conventional approach provides an even frequency of occurrence (˜33% ) for the high, medium and low range of profitability. The stochastic technique, on the other hand, shows that the likelihood that the maximum profitability will be $7,681 is substantially higher than that the net gain will be less than or equal to $6,230. Therefore, the stochastic methodology results in an improved probability distribution where the high profitability ranges are more likely to occur than the low profitability ranges.

The presently disclosed subject matter may also be embodied as a computer-readable storage medium having executable instructions for performing the various processes as described herein. The storage medium may be any type of computer-readable medium (i.e., one capable of being read by a computer), including non-transitory storage mediums such as magnetic or optical tape or disks (e.g., hard disk or CD-ROM), solid state volatile or non-volatile memory, including random access memory (RAM), read-only memory (ROM), electronically programmable memory (EPROM or EEPROM), or flash memory. The term “non-transitory computer-readable storage medium” encompasses all computer-readable storage media, with the sole exception being a transitory, propagating signal. The coding for implementing the present invention may be written in any suitable programming language or modeling system software, such as AIMMS. Solvers that can be used to solve the equations used in the present invention include CPLEX, XPress, and GUROBI.

The presently disclosed subject matter may also be embodied as a computer system that is programmed to perform the various processes described herein. The computer system may include various components for performing these processes, including processors, memory, input devices, and/or displays. The computer system may be any suitable computing device, including general purpose computers, embedded computer systems, network devices, or mobile devices, such as handheld computers, laptop computers, notebook computers, tablet computers, mobile phones, and the like. The computer system may be a standalone computer or may operate in a networked environment.

Although the various systems, modules, functions, or components of the present invention may be described separately, in implementation, they do not necessarily exist as separate elements. The various functions and capabilities disclosed herein may be performed by separate units or be combined into a single unit. Further, the division of work between the functional units can vary. Furthermore, the functional distinctions that are described herein may be integrated in various ways.

The foregoing description and examples have been set forth merely to illustrate the invention and are not intended to be limiting. Each of the disclosed aspects and embodiments of the present invention may be considered individually or in combination with other aspects, embodiments, and variations of the invention. Modifications of the disclosed embodiments incorporating the spirit and substance of the invention may occur to persons skilled in the art and such modifications are within the scope of the present invention.

1. A method of raw material procurement optimization at a facility, comprising:
(a) using a computer system that stores price and availability data of raw materials in a database,
(b) optimizing valuation of the raw materials by using a mathematical valuation model,
wherein a raw material procurement scenario tree is created and divided into a plurality of stages in time, the scenario tree including a plurality of individual scenarios,
wherein the price and availability data of the raw materials is assigned probability of occurrence in future stages in time and the data is input into the scenario tree, and
wherein the mathematical valuation model processes the price and availability data of the raw materials including the probability of occurrence of the data, and calculates an optimal raw material procurement scenario among the plurality of individual scenarios,
(c) optimizing negotiating sequence by a mathematical negotiation model, wherein the negotiating sequence determines order of the raw material procurement, and
(d) performing procurement according to the calculated optimal raw material procurement scenario.

2. The method of claim 1, wherein each of the plurality of individual scenarios includes raw material procurement decisions that cumulatively amount to a full capacity of the facility.

3. The method of claim , wherein each of the plurality of individual scenarios extends from a moment in time of the calculation of the optimal raw material procurement scenario to a moment in time when the facility reaches the full capacity.

4. The method of claim 1, wherein each of the plurality of individual scenarios includes raw material procurement decisions at each of the plurality of stages of the scenario tree.

5. The method of claim 1, wherein the stored price and availability data of the raw materials includes a predicted price for each of the raw materials in the future stages of the scenario tree, and a volatility of each corresponding predicted price.

6. The method of claim 5, wherein the volatility of each corresponding predicted price is determined based on historical market conditions.

7. The method of claim 1, wherein the database includes data regarding mutual compatibility among the raw materials.

8. The method of claim 7, wherein each of the plurality of individual scenarios accounts for the data regarding mutual compatibility among the raw materials.

9. The method of claim 1, wherein decisions made at a node of the scenario tree carry over to nodes of subsequent stages of the scenario tree originating from said node.

10. The method of claim 1, wherein the order of the raw material procurement is based on negotiation of the price and the availability of the raw material.

11. A method of raw material procurement optimization at a facility, comprising:
(a) using a computer system that stores price and availability data of raw materials in a database,
(b) optimizing valuation of the raw materials by using a mathematical valuation model,
wherein a raw material procurement scenario tree is created and divided into a plurality of stages in time, the scenario tree including a plurality of individual scenarios,
wherein the stored price and availability data of the raw materials includes a predicted price for each of the raw materials in future stages of the scenario tree, and a volatility of each corresponding predicted price,
wherein the mathematical valuation model processes the price and availability data of the raw materials including the volatility of each corresponding predicted price, and calculates an optimal raw material procurement scenario among the plurality of individual scenarios,
(c) optimizing negotiating sequence by a mathematical negotiation model, wherein the negotiating sequence determines order of the raw material procurement, and
(d) performing procurement according to the calculated optimal raw material procurement scenario.

12. The method of claim 11, wherein each of the plurality of individual scenarios includes raw material procurement decisions that cumulatively amount to a full capacity of the facility.

13. The method of claim 12, wherein each of the plurality of individual scenarios extends from a moment in time of the calculation of the optimal raw material procurement scenario to a moment in time when the facility reaches the full capacity.

14. The method of claim 11, wherein each of the plurality of individual scenarios includes raw material procurement decisions at each of the plurality of stages of the scenario tree.

15. The method of claim 11, wherein the volatility of each corresponding predicted price is determined based on historical market conditions.

16. The method of claim 11, wherein the database includes data regarding mutual compatibility among the raw materials.

17. The method of claim 16, wherein each of the plurality of individual scenarios accounts for the data regarding mutual compatibility among the raw materials.

18. The method of claim 11, wherein decisions made at a node of the scenario tree carry over to nodes of subsequent stages the scenario tree originating from said node.

19. The method of claim 11, wherein the order of the raw material procurement is based on negotiation of the price and the availability of the raw material.
